(19) United States
(12) Patent Application Publication
(10) Pub. No.: US 2023/0187767 A1
(43) Pub. Date: Jun. 15, 2023

(54) BATTERY ARRANGEMENT AND METHOD FOR DISCHARGING A GAS FROM A BATTERY ARRANGEMENT

(71) Applicant: AUDI AG, Ingolstadt (DE)

(72) Inventors: Tobias BENKER, Heilbronn (DE); Lukas DÖBBELIN, lngolstadt (DE); Marc GORMANNS, Erlenbach (DE); Ruben HEID, Bammental (DE); Victor SCHMADALLA, Nürnberg (DE); Martin SIMON, Reichertshofen (DE); Matthias WIMMI, Neuenstadt am Kocher (DE); Michael SCHUESSLER, Neckarsulm (DE)

(73) Assignee: AUDI AG, Ingolstadt (DE)

(21) Appl. No.: 18/075,722

(22) Filed: Dec. 6, 2022

(30) Foreign Application Priority Data
Dec. 9, 2021 (DE) 102021132480.7

(51) Int. Cl. H01M 50/317; H01M 10/613; H01M 10/6556; H01M 50/204

(52) U.S. Cl. CPC H01M 50/317; H01M 10/613; H01M 10/6556; H01M 50/204; H01M 2220/20

(57) ABSTRACT

A battery arrangement having a housing base arrangement and at least one battery unit which is arranged on the housing base arrangement and is arranged above the housing base arrangement with respect to a first direction and which comprises at least one battery cell. The at least one battery cell has a first side having a releasable degassing opening which is releasable for discharging a gas from the at least one battery cell. The housing base arrangement has at least one predetermined breaking point, which is designed, in dependence on a gas escape of a gas from the degassing opening of the at least one battery cell, to release an opening penetrating the housing base arrangement with respect to the first direction, in order to discharge the gas escaping from the degassing opening of the at least one battery cell through the released opening.

### FIELD

The invention relates to a battery arrangement having a housing base arrangement and at least one battery unit which is arranged on the housing base arrangement and is arranged above the housing base arrangement with respect to a first direction and which comprises at least one battery cell, wherein the at least one battery cell has a first side having a releasable degassing opening which is releasable for discharging a gas from the at least one battery cell. Furthermore, the invention also relates to a method for discharging a gas from a battery arrangement.

### BACKGROUND

In electric vehicles, the batteries, in particular high-voltage batteries, are usually installed in a so-called battery tray. Such a battery tray has the functions of protecting against crash loads and protecting against environmental influences such as dirt and moisture. As a result, the battery tray is designed as a sealed volume that as much as possible prevents any substance exchange with the surroundings. In case of a malfunction or in case of an accident, so-called thermal propagation, i.e., thermal runaway, of one or more cells of the battery can occur under certain circumstances. The cell overheats strongly and quickly and develops chemical reaction products with strong gas expansion. For this purpose, battery cells usually have releasable degassing openings so that the gas can escape from such a cell in a controlled manner. If such a gas expansion takes place in the closed battery tray, a strong overpressure develops which, in the worst case, results in an explosive escape of the gases from the battery tray. The releasable degassing openings of battery cells are usually designed as bursting membranes.

For example, DE 10 2020 102 221 A1 describes a battery cell having a cell housing having a predetermined rupture point, wherein the rupture point is designed to rupture when a predetermined limiting pressure in an interior of the cell housing is exceeded and to allow a gas and/or jet of fire to escape from the interior of the cell housing.

Furthermore, DE 10 2011 078 301 A1 describes a battery cell that comprises a housing that has a gas outlet opening, wherein the battery cell comprises a check valve that allows a gas flow from the housing interior to the surroundings of the housing through the gas outlet opening and can substantially prevent a gas flow from the surroundings of the housing into the housing interior through the gas outlet opening.

In this way, gases produced in a battery cell can be deliberately discharged therefrom, but a defined discharge of gases from the battery housing itself, such as the above-described battery tray, in which the battery cells are arranged, is not enabled in this way.

### SUMMARY

It is therefore the object of the present invention to provide a battery arrangement and a method which enable gases escaping from a battery cell to be discharged in the safest and most efficient manner possible.

A battery arrangement according to the invention has a housing base arrangement and at least one battery unit which is arranged on the housing base arrangement and is arranged above the housing base arrangement with respect to a first direction and which comprises at least one battery cell, wherein the at least one battery cell has a first side having a releasable degassing opening which is releasable for discharging a gas from the at least one battery cell. In addition, the housing base arrangement has at least one predetermined breaking point, which is designed, in dependence on a gas escape of a gas from the degassing opening of the at least one battery cell, to release an opening penetrating the housing base arrangement with respect to the first direction, in order to discharge the gas escaping from the degassing opening of the at least one battery cell through the released opening

The opening to be released for discharging the gases therefore only arises when the predetermined breaking point breaks. The invention is based on several findings at the same time: On the one hand, it would be conceivable to counteract the risk of explosion of a battery housing, such as the battery tray described at the outset, by installing so-called pressure relief valves or relief valves, also known as vents, in the battery tray, which discharge the gas flow to the outside from a specific overpressure. However, such vents then have to be installed in a separate assembly process and can only be attached to certain areas of the battery tray, above all not to an underside of the battery tray, which provides the housing base, so to speak. This in turn is due to the fact that the housing base is usually designed as a cooling base and the cells or cell modules are to be thermally connected to it as well as possible. For this purpose, the base is to be made as flat as possible and the cells or cell modules can be connected to it via a gap-filling thermal interface material. The integration of vents in this base would result in local irregularities and, above all, an increase in the gap height between the base and the battery modules or cells, which would obstruct efficient heat dissipation and a good thermal connection. In addition, the provision of separately formed vents is linked to additional costs. All of these problems may now be advantageously solved by the invention in that no separately formed valves are used for the gas discharge, but instead at least one predetermined breaking point is provided, which releases an opening, in dependence on a gas escape from the degassing opening of the at least one battery cell, through which the gas escaping from the degassing opening of the at least one battery cell can be discharged. Such a predetermined breaking point may be provided much more simply and cost-effectively, since no extra component is required for this purpose, which has to be introduced in a separate assembly process. In addition, such a predetermined breaking point does not require any additional installation space. On the contrary, such a predetermined breaking point can be provided, for example, simply as a material weakening, which does not increase the overall height in the corresponding area in which the predetermined breaking point is provided, but rather, if it changes at all, reduces it. This in turn advantageously makes it possible to provide such a predetermined breaking point on the underside of a battery housing, which is provided in the present case by the housing base arrangement. The housing base arrangement can therefore be part of a battery housing and in particular can provide the housing underside of such a battery housing. The housing base arrangement can thus comprise a housing base, for example, which delimits a receptacle area of a battery housing downward with respect to the first direction. However, the housing base arrangement preferably consists not only of such a housing base, but can also be constructed from multiple layers, as will be explained in more detail hereinafter. The provision of a predetermined breaking point in the housing base arrangement, i.e., on the underside of the battery housing, in turn has the great advantage that this allows the gas flow to be provided in a direction with the least harmful effect on the occupants of a vehicle in which the battery arrangement is used. The battery arrangement is preferably arranged in a motor vehicle in such a way that the above-mentioned first direction is aligned parallel to a vertical axis of the vehicle and in particular points upwards, and the battery arrangement is also arranged in an underbody area of the motor vehicle, in particular below a passenger compartment. The housing base arrangement of the battery arrangement thus represents the side of the battery arrangement facing away from the passenger compartment. A gas escaping via the predetermined breaking point is thus directed in the direction of an underride protection of the motor vehicle and can, for example, be deliberately discharged via the intermediate space between the housing base arrangement and the underride protection. As a result, safety may be significantly increased in comparison to previous concepts, and this may also be implemented in a particularly simple and cost-effective manner. The risk of a battery housing exploding is minimized or eliminated as a result, and a particularly safe downward gas discharge path is also made possible.

For example, a motor vehicle battery, in particular a high-voltage battery for a motor vehicle, can be provided by the battery arrangement. Such a battery can have not just one battery cell, but preferably multiple battery cells. These battery cells can be formed, for example, as lithium-ion cells. The battery cells can optionally be combined into battery modules. Such a battery module can, for example, comprise multiple battery cells arranged in a module housing. The at least one battery unit comprised by the battery arrangement, which comprises the at least one battery cell, can be such a battery module, for example. If such a battery module has a separate module housing, it is preferred that this likewise has an at least releasable or permanent opening in the area of the releasable degassing opening of the battery cell. However, the battery cells do not necessarily have to be arranged in battery modules. For example, the battery cells of the battery can also be arranged without an additional separate module housing in the battery housing, for example the battery tray described at the outset. The battery unit comprised by the battery arrangement can also be the at least one battery cell itself, for example. In other words, in this case the battery unit does not comprise any further component except for the at least one battery cell. The battery arrangement can therefore have a battery housing, for example, in which the battery unit having the at least one battery cell is arranged. The housing base arrangement can in turn have a housing base, which can then simultaneously represent the base of the battery housing.

Furthermore, the predetermined breaking point is preferably designed in such a way that the housing base arrangement in a normal operating state, in which no gas escapes from the at least one battery cell, in particular from none of the battery cells of the battery arrangement, has no opening, in particular no perforation opening completely penetrating the housing base arrangement or the like. This has the advantage that in this way the protection against environmental influences such as dirt and moisture can be maximized by the housing base arrangement. Nevertheless, the predetermined breaking point can still comprise perforation openings, which then preferably only penetrate some of the layers of the housing base arrangement, and are also preferably made significantly smaller than the opening ultimately to be released by the predetermined breaking point upon breaking.

Furthermore, the housing base arrangement can have not only one such predetermined breaking point, but also several. The number of such predetermined breaking points can be selected depending on the requirement.

In a particularly advantageous embodiment of the invention, the battery unit is arranged on the housing base arrangement in such a way that the first side of the at least one battery cell faces toward the housing base arrangement. As a result, the gas escaping from the battery cell reaches the area of the predetermined breaking point significantly more quickly and can therefore be discharged in a significantly more direct way. In addition, this has the great advantage that the gas flow escaping from the battery cell, which in the case of thermal propagation of the battery cell partially leaves the cell as an extremely hot gas-particle flow, is directed downwards and thus in turn away from the passenger compartment in relation to the intended arrangement of the battery arrangement in a motor vehicle. The hazard potential for occupants can in turn be significantly reduced as a result. Reinforcing and protective measures in the base area of the passenger compartment can also be made correspondingly less complex or can be omitted.

In a further very advantageous embodiment of the invention, the housing base arrangement has a housing base which is designed as a cooling base through which a coolant can flow. As a result, underside cooling for the battery cells or in general for the at least one battery cell of the battery arrangement can advantageously be provided at the same time during normal operation. The at least one battery cell can also be designed in such a way that its cell poles are not arranged on the first side of the battery cell on which the releasable degassing opening is also arranged. This simplifies the thermal connection of the at least one battery cell to the cooling base.

In a further advantageous embodiment of the invention, the housing base arrangement has a housing base, in particular the above-mentioned housing base, and an electrically insulating layer, in particular a plastic film, which is arranged between the battery unit and the housing base, and/or a thermal interface layer arranged between the battery unit and the housing base for thermally coupling the housing base and the battery unit.

The electrically insulating layer is used for electrical protection, since preferably both the housing of the battery cells or the battery unit and the housing base itself are made of metallic material, for example aluminum. It is preferred that such an insulating layer, for example a plastic film, is located directly on the upper side of the housing base with respect to the first direction, i.e., on the side of the housing base facing toward the battery unit. Especially when the housing base is designed as a cooling base at the same time, it is also particularly advantageous if the housing base arrangement has a thermal interface layer, which is then provided between the housing base and the battery unit for better thermal coupling of the housing base and the battery unit. Such a thermal interface layer can be provided, for example, by a gap filler, which represents a thermally conductive compound that is introduced, for example, during production of the battery arrangement in a viscous or pasty state between the battery unit and the housing base and then cures. However, the thermal interface layer can also be provided as a so-called gap pad, which represents a type of very thin thermal pad. This is then neither pasty nor viscous during the production process or afterwards, but is permanently in a solid but flexible state. Under certain circumstances, such a gap pad can also assume the electrically insulating function, so that no additional electrically insulating layer, for example in the form of an additional plastic film, is then required. Nevertheless, such a film can still be provided. If the housing base arrangement has both an electrically insulating layer and a thermal interface layer, then the electrically insulating layer is preferably arranged between the housing base and the thermal interface layer. The electrically insulating layer then also offers protection, for example, in areas in which there is no thermal interface layer.

The thermal interface layer then preferably contacts the battery cell and/or the at least one battery unit directly, at least in some areas. The thermal interface layer can also extend beyond the releasable degassing opening of the battery cell and contact or wet it directly, or also leave it free, as will be explained in more detail hereinafter.

There are numerous different options for providing the predetermined breaking point in the housing base arrangement. In particular, such a predetermined breaking point can be provided by a targeted weakening of one or more of the above-mentioned layers of the housing base arrangement.

According to an advantageous embodiment of the invention, the predetermined breaking point is formed as a local weakening of the housing base, in particular wherein the local weakening is provided by a material weakening and/or a connecting point, in particular a weakened connecting point, at which a first part of the housing base is connected to a second part of the housing base. If the housing base is therefore assembled from multiple separate parts, in particular in a direction perpendicular to the first direction, such joining points, which are referred to here as connecting points, can themselves function as predetermined breaking points and/or these connecting points can be made additionally weakened, at least in certain areas, in order to provide such a predetermined breaking point. Such a connecting point or joining point can generally be provided, for example, by a solder, a roll bond, a weld seam, an adhesive bond, or the like. In order to provide the predetermined breaking point, this connecting point can then locally, for example, be made less wide or less stable, or it can be interrupted in some areas or the like. Additionally or alternatively, the predetermined breaking point can also be provided as a material weakening in another area of the housing base, that is to say in an area of the housing base in which there is no connecting point.

The provision of the predetermined breaking point at least as a local weakening of the housing base has the great advantage that in this way the opening to be released can be opened in a particularly safe manner in case of degassing of the cell, since the housing base typically represents the most robust layer of the above-mentioned optional layers of the housing base arrangement. The provision of a local weakening in the housing base is therefore particularly advantageous in order to ensure safe opening of the predetermined breaking point. In this case, the local weakening in the housing base can additionally be combined with a local weakening in one or more of the optional further layers of the housing base arrangement or can be restricted only to the housing base.

In a further advantageous embodiment of the invention, the predetermined breaking point is designed as a local weakening of an element of the housing base arrangement that is different from the housing base, in particular as a material weakening of the element that is different from the housing base. Here too, however, a local weakening of the housing base itself can also optionally be provided, as has been described above. The predetermined breaking point can therefore additionally or alternatively also be provided as a local weakening, for example of the electrically insulating layer and/or the thermal interface layer. In this case, the formation of a local weakening in the electrical insulation layer is less preferred, since this is formed very thin anyway, particularly if it is provided as a plastic film. The local weakening can also be implemented simply by locally omitting one of the layers described to provide the predetermined breaking point, for example in the form of a hole or a recess in this relevant layer.

According to a further advantageous embodiment of the invention, the material weakening, in particular both in the housing base and alternatively or additionally in the electrically insulating layer and/or the thermal interface layer, can be provided by: at least one perforation line, which extends straight or curved, and which is formed in particular as an open or closed perforation line, and/or a material taper along at least one line, such as a notch or groove or score mark or bead or embossing, which in turn extends straight or curved, and which in particular can also be as an open line or as a closed line, and/or a hole in an element of the housing base arrangement which corresponds to the size of the opening to be released and which is covered by a further element of the housing base arrangement when no gas is escaping from the at least one cell, and/or at least one blind hole that corresponds to the size of the opening to be specified, and/or multiple blind holes extending along at least one line. Again, this line can extend straight or curved, and can be formed as a closed line or as an open line. Numerous possibilities are thus provided for implementing a predetermined breaking point. An element of the housing base arrangement is to be understood in particular as one of the layers mentioned, namely the housing base, the electrically insulating layer, and the thermal interface layer. If the predetermined breaking point is formed, for example, as a hole in an element of the housing base arrangement that corresponds to the size of the opening to be released, for example as a corresponding hole in the housing base itself, this hole can be covered by at least one further one of the elements of the housing base arrangement, for example the plastic film, when no gas is escaping from the at least one cell. In particular, a hole can also be provided in two of the elements of the housing base arrangement in the area of the predetermined breaking point, for example both in the thermal interface layer and in the housing base itself, so that at the predetermined breaking point there is only still the plastic film covering these holes, for example, which then acts as a bursting membrane.

There are numerous advantageous options for implementing the predetermined breaking point as a failure area. In addition to the failure of the housing base itself, the predetermined breaking point can also be implemented by the failure of an additional component, for example a membrane, e.g., the plastic film, and/or the gap filler or gap pad. The deliberate failure area can be covered by a thermally conductive material that also fails in the event of a failure, in particular due to the low mechanical properties of the material, such as the gap filler in this example. The deliberate failure area can additionally be covered by a membrane or film, in particular the plastic film, which also fails in the event of a failure. It is also conceivable that the failure area is designed in such a way that the material is already perforated and, for example, is only sealed off from the surroundings by the film, the thermally conductive pad, or the gap filler.

In order to provide such material weakenings, various manufacturing methods such as laser sublimation, laser perforation, perforation, drilling, milling, and so on come into consideration. In particular, the predetermined breaking point can be provided by a so-called tailored blank, in which different materials can be used, as well as a heat treatment, and/or different cross sections can be provided, for example, via a factory process. The predetermined breaking point can extend straight or curved, in particular can be provided according to a free form which is provided by blind holes, holes, scores, or beads, wherein line patterns or hole patterns are generally provided, in particular continuous failure lines or interrupted or perforated failure lines. The material weakenings described can also be combined with one another as desired to provide a predetermined breaking point. In addition, the battery arrangement can also have multiple differently formed predetermined breaking points in different elements of the housing base arrangement.

In a further advantageous embodiment of the invention, the releasable degassing opening of the at least one battery cell is adjoined by a cavity which provides a gas discharge channel and which, with respect to the first direction, is delimited by at least a part of the housing base arrangement, in particular at least the housing base and the electrically insulating layer located on the housing base. In the area of this cavity, for example, the thermal interface layer can thus be omitted, at least locally. Such a degassing channel advantageously also makes it possible to couple multiple releasable degassing openings of battery cells with one another or to connect multiple such degassing openings to this degassing channel. In this degassing channel, in particular in the part of the housing base arrangement that delimits this degassing channel downwards, one or more predetermined breaking points can be specified, the number of which can be selected independently of the number of degassing openings of the battery cells coupled to the degassing channel. In other words, for example, significantly fewer predetermined breaking points than degassing openings that are coupled to the degassing channel can be provided, or if necessary more. For example, only one such predetermined breaking point can be provided in the degassing channel. Laterally, i.e., perpendicularly to the first direction, this degassing channel can be delimited, for example, by a separate wall or by the mentioned gap filler layer or the gap pad or also by parts of other elements of the housing base arrangement.

In a further advantageous embodiment of the invention, the releasable degassing opening of the at least one battery cell is directly adjacent to the housing base arrangement, wherein the predetermined breaking point is clearly associated with the degassing opening in that the predetermined breaking point is arranged directly below the degassing opening with respect to the first direction. In this example, the degassing opening of the battery cell can, for example, also make direct contact with the thermal interface layer or be wetted thereby. In this case, therefore, no degassing channel is provided which can fluidically couple multiple degassing openings to one another. This has the advantage, for example, that in case of a thermal event there is no thermal coupling of the cells via this degassing channel. In other words, a significantly better thermal decoupling from neighboring cells may be provided in this way in case of a thermal event. However, in this case, at least one such predetermined breaking point in the housing base arrangement is then clearly associated with each degassing opening of a cell. This predetermined breaking point can, for example, be formed as a hole in the bottom of the housing, which is located directly below the degassing opening of the cell, so that the degassing opening is separated from the hole by the functional insulation film and the thermal interface layer, which is usually only made very thin and is a few millimeters, for example one to two millimeters. Other embodiments are again also conceivable here.

The fact that the predetermined breaking point is associated with precisely one degassing opening of a cell may be effectuated simply by the predetermined breaking point being located directly below the degassing opening with respect to the first direction. The predetermined breaking point is then correspondingly designed to release the opening in the housing base arrangement only when a gas escapes from the associated degassing opening of the associated cell.

The battery arrangement according to the invention or its embodiments are preferably designed as a high-voltage battery for a motor vehicle. A motor vehicle having a battery arrangement according to the invention or one of its embodiments should also be regarded as included in the invention. The battery arrangement can be arranged in the motor vehicle as already described above.

The motor vehicle according to the invention is preferably embodied as an automobile, in particular as a passenger car or truck, or as a passenger bus or motorcycle.

Furthermore, the invention also relates to a method for discharging a gas from a battery arrangement having a housing base arrangement and at least one battery unit which is arranged on the housing base arrangement and is arranged above the housing base arrangement with respect to a first direction and which comprises at least one battery cell, wherein the at least one battery cell has a first side having a releasable degassing opening which is releasable for discharging a gas from the at least one battery cell. In this case, the housing base arrangement has at least one predetermined breaking point, which, in dependence on a gas escape from the degassing opening of the at least one battery cell, releases an opening penetrating the housing base arrangement with respect to the first direction, in order to discharge the gas escaping from the degassing opening of the at least one battery cell through the released opening

The advantages mentioned for the battery arrangement according to the invention and its embodiments thus apply similarly to the method according to the invention.

The invention also includes refinements of the method according to the invention, which have features as have already been described in conjunction with the refinements of the battery arrangement according to the invention. For this reason, the corresponding refinements of the method according to the invention are not described again here.

The invention also comprises combinations of the features of the described embodiments. The invention also includes implementations that each have a combination of the features of several of the described embodiments, unless the embodiments were described as mutually exclusive.

### BRIEF DESCRIPTION OF THE FIGURES

Exemplary embodiments of the invention are described hereinafter. In the figures:

FIG. 1 shows a schematic cross-sectional illustration of a battery arrangement according to one exemplary embodiment of the invention;

FIG. 2 shows a schematic illustration of a housing base having a predetermined breaking point for a battery arrangement in a top view according to one exemplary embodiment of the invention;

FIG. 3 shows a schematic illustration of the housing base for the battery arrangement having a predetermined breaking point in a top view according to a further exemplary embodiment of the invention;

FIG. 4 shows a schematic illustration of a housing base in a top view having a predetermined breaking point according to another exemplary embodiment of the invention;

FIG. 5 shows a schematic illustration of the housing base in a top view having a predetermined breaking point for a battery arrangement according to another exemplary embodiment of the invention; and

FIG. 6 shows a schematic cross-sectional illustration of a battery arrangement according to another exemplary embodiment of the invention.

### DETAILED DESCRIPTION

The exemplary embodiments explained hereinafter are preferred embodiments of the invention. In the exemplary embodiments, the described components of the embodiments each represent individual features of the invention to be considered independently of one another, which each also refine the invention independently of one another and are thus also to be considered to be part of the invention individually or in a combination other than that shown. Therefore, the disclosure is also intended to comprise combinations of the features of the embodiments other than those shown. Furthermore, the described embodiments can also be supplemented by further ones of the already described features of the invention.

In the figures, same reference numerals respectively designate elements that have the same function.

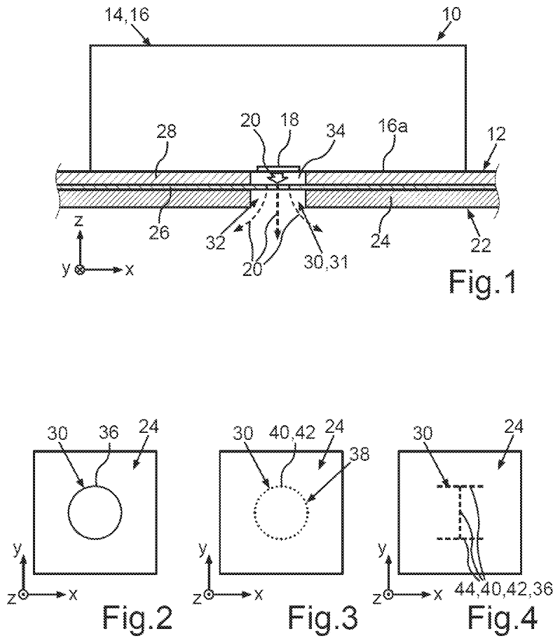

FIG. 1 shows a schematic illustration of a battery arrangement 10 according to one exemplary embodiment of the invention. The battery arrangement 10 has a housing base arrangement 12 and a battery unit 14 which is arranged on the housing base 12 and comprises at least one battery cell 16, wherein the battery unit 14 represents the battery cell 16 in this example. In this example, a prismatic battery cell 16 is illustrated, but this can also be formed in any other way. The battery cell 16 can be, for example, a lithium-ion cell. The battery cell 16 has a first side 16a, which defines an underside 16a of the battery cell 16 in this example. On this first side 16a, the battery cell 16 also has a releasable degassing opening 18, which can be formed using a bursting membrane, for example. In case of a thermal event, the gas produced in the cell 16 can be deliberately discharged from this releasable degassing opening 18. The gas escaping from the cell 16 is illustrated by the arrow 20 in FIG. 1 as an example. The battery cell 16 is also arranged in a battery housing 22, of which only the housing base 24 is shown as an example in FIG. 1. In the present example, the battery cell 16 or the battery unit 14 is generally not arranged directly on the housing base 24, but an electrical insulation layer in the form of a plastic film 26 is initially also arranged on the housing base 24 and between this plastic film 26 and the battery cell 16 or the battery unit 14, a thermal interface layer 28 is also arranged, which can be designed, for example, as a gap filler or gap pad. These two layers, namely the plastic film 26 and the thermal interface layer 28, are also part of the housing base arrangement 12.

In order to prevent the gas 20 escaping from the cell 16 from causing the battery housing 22 to explode in an uncontrolled manner, the housing base arrangement 12 advantageously has a predetermined breaking point 30, which in the present example is provided by an opening or a hole 31 in the housing base 24. This predetermined breaking point 30 thus represents a failure area which is designed to release an opening 32 penetrating the housing base arrangement 12 in the illustrated z direction in case of degassing of the cell 16, so that the gas 20 escaping from the cell 16 can be discharged through this opening 32, which is shown in FIG. 1 is shown in the still closed state, in particular from the battery housing 22. As a result, several major advantages can be achieved at the same time: On the one hand, controlled gas discharge can be made possible, which prevents the battery housing 22 from exploding in an uncontrolled manner By designing this gas discharge option not as a separate valve or component, but as a predetermined breaking point 30 in the housing base arrangement 12 itself, it is also possible to save enormous costs on the one hand and on the other hand to make this discharge option significantly lower in height. In particular, this does not increase the installation space required for the housing base arrangement 12 in the z direction. This makes it possible for such a discharge option to be integrated into the bottom of the battery housing 22 in the first place. The housing base 24 is moreover preferably designed as a cooling base. This can, for example, also have cooling channels (not shown here), through which a coolant can flow. The integration of the predetermined breaking point 30 in the housing base arrangement 12 advantageously allows the gas 20 escaping from the battery cell 16 to be deliberately directed away from a passenger compartment of the motor vehicle in which the battery arrangement 10 is used. The battery arrangement 10 is preferably arranged in a motor vehicle in such a way that the Z axis shown here is aligned in the direction of a vehicle vertical axis. The gas can thus be deliberately introduced into a harmless area, for example between the housing base 24 and an underride protection of the motor vehicle. From there, the gas 20 can be deliberately discharged, for example in the direction of a vehicle rear.

In the present example, the predetermined breaking point 30 is shown directly below the releasable degassing opening 18 of the cell 16 in relation to the y direction shown. However, this predetermined breaking point can also be arranged offset in the y direction with respect to the degassing opening 18. If gas 20 escapes from the cell 16, it is first introduced into a degassing channel or gas discharge channel 34, which is embodied by a cavity adjacent to the degassing opening 18. For example, multiple cells 16 or battery units 14 can also be arranged next to one another in the y direction, so that this cavity 34 is arranged as a common gas discharge channel 34 below a respective degassing opening 18 of such a cell 16. For this entire degassing channel 34, for example, only one predetermined breaking point 30 or only a few predetermined breaking points 30 can be provided in the housing base arrangement 12, which are in particular significantly fewer in number than the degassing openings 18 coupled or capable of being coupled to the degassing channel 34. In this case, the gas discharge channel 34 can thus extend over multiple cells in the y direction, and the film 26 can also be made continuous in the y direction, while the hole 31 is locally restricted in the y direction, preferably to only a small area. For example, the hole 31 can be made circular. As a result, the housing base arrangement 12 does not lose its stability.

In this example, the predetermined breaking point 30 in the housing base arrangement 12 is provided by the hole in the housing base 24 and in particular also in the thermal interface layer 28 for providing the cavity 34 for the gas discharge channel 34 being provided there. The housing base arrangement 12 thus only still consists of the plastic film 26 in the area of the predetermined breaking point 30. However, numerous other design options for providing a predetermined breaking point 30 are also conceivable. In particular, a hole does not necessarily have to be provided in the housing base 24 at this point. This can also only be weakened at this point. There are various options for providing such a local weakening, which are explained in more detail hereinafter.

For this purpose, FIG. 2 shows a schematic illustration of the housing base 24 for a battery arrangement 10, as described with reference to FIG. 1, for example, in a top view, wherein the housing base 24 can be formed as described above except for the differences described hereinafter. In this example, the housing base 24 has a predetermined breaking point 30 which is formed as a material taper 36 along a line, in particular a closed line in this example. In this example, the predetermined breaking point 30 is therefore provided as a closed score track 36 or groove. It can also be provided in some form of notch or embossing. In this case, the housing base 24 is not completely broken through in the z direction, but is made thinner than the other areas in the z direction due to the design described.

FIG. 3 shows a schematic representation of another example of a housing base 24, again in a top view. In this example, the predetermined breaking point is provided as a circular and closed perforation line 38 which has multiple individual perforation holes 40 arranged in a circle. These can therefore completely penetrate the housing base in the z direction. Alternatively, it is also conceivable that this perforation line 38 is not provided by continuous perforation holes 40 but by blind holes 42. These then correspondingly do not penetrate the housing base 24 completely in the z direction. In both cases, this allows a perforated or at least partially perforated line 38 to be provided as a predetermined breaking point 30.

FIG. 4 shows another example of a housing base 24 having a predetermined breaking point 30. In this example, this is also formed as a material weakening, which, however, is not provided along a closed line, but rather along multiple non-closed lines. The material weakening can again be provided along these lines 44 in the form of perforation holes 40 or blind holes 42 or again as a continuous groove 36.

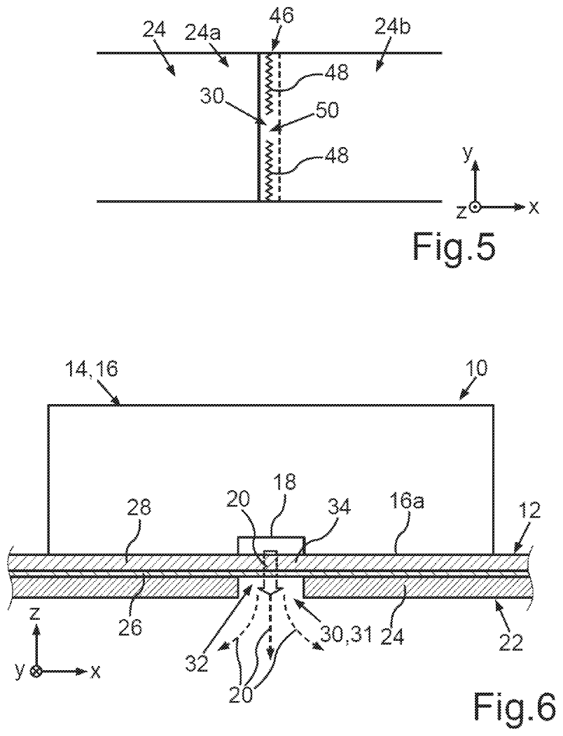

FIG. 5 shows a further example of a possible embodiment of a housing base 24 having a predetermined breaking point 30. In this example, the housing base 24 is again shown in a top view of the z direction. In addition, the housing base 24 in this example has a first part 24a and a second part 24b, which are connected to one another along a joining area 46. A joint connection is denoted by 48 in the present case. Such a joint connection can be provided, for example, by welding, roll bonding, adhesive bonding, or the like. In this example, this joint connection 48 is weakened or not implemented at all in an area 50, which accordingly then provides the predetermined breaking point 30. A joining area 46 can thus advantageously also be used to provide a predetermined breaking point 30.

The above-described possible embodiments of the predetermined breaking point 30 as a material weakening in the housing base 24 can additionally or alternatively also be implemented analogously in the other layers of the housing base arrangement 12 in order to provide such a predetermined breaking point 30. However, it is advantageous if such a predetermined breaking point does not provide a through opening that completely penetrates the housing base arrangement 12 in the z direction during normal operation. In the case of the provision of perforation holes 40, for example, it is correspondingly advantageous if, for example, another of the layers of the housing base arrangement 12 covers these continuous perforation holes 40 accordingly.

FIG. 6 shows a cross section of a battery arrangement 10 according to an exemplary embodiment of the invention. This battery arrangement can also be designed, for example, as described for FIG. 1, except for the differences described hereinafter. In this example, no gas discharge channel 34 is provided as described for FIG. 1. Instead, in this example, the thermal interface layer 28 also contacts the first side 16a of the cell 16 in the area of the degassing opening 18. In other words, the releasable degassing opening 18 of the cell 16 is covered in the normal operating state by the thermal interface layer 28, i.e., for example, the gap pad or the gap filler material. In this example, the predetermined breaking point 30 is again formed as an opening 31 in the housing base 24. As a result, the housing base arrangement 12 is weakened in the area of the degassing opening 18 in comparison to the other areas, i.e., in areas in which no such predetermined breaking point 30 is provided. In this case, this opening 31 is located at least directly below the degassing opening 18 in relation to the z direction and can therefore not be arranged offset in relation to it in the y direction, as can be the case in FIG. 1. In the case of a multiple cells 16 having respective degassing openings 18, one associated predetermined breaking point 30 can be provided per degassing opening 18 here. It would also be conceivable, for example, to form the hole 31 in the housing base 24 in an elongated manner, so that one predetermined breaking point 30 is provided for multiple degassing openings 18 at the same time. However, this makes the housing base 24 significantly less stable overall.

This represents a particularly advantageous embodiment, since in this example there is no need to keep ready a recessed area for the provision of a degassing channel which, for example, is not wetted using gap filler material. This enables a thermal interface layer 28 to be introduced over a large area, onto which the cells 16 or battery units 14 can simply be placed. Since both the plastic film 26 and this thermal interface layer 28 are relatively thin, a predetermined breaking point 30 can also be provided in this way in an advantageous manner.

Overall, the examples show how a novel concept for a bottom venting battery tray can be provided by the invention. The invention or its embodiments use the idea of deliberately incorporating failure areas in one or more components. The overpressure regulation of the battery tray then does not take place via separately installed vents. Instead, the battery ventilation is integrated directly into the base, in particular the cooling base, of the battery tray. For this purpose, the cooling base consisting of aluminum sheet can be deliberately provided with predetermined breaking points. If an excessive pressure increase occurs, the cooling base will fail at the predetermined breaking point and relieve the gas pressure. As a result, no additional component in the sense of a relief valve is advantageously required. The component and the associated assembly process can be saved completely. The ventilation can be carried out over a significantly larger area and thus contributes to occupant protection. The ventilation can take place in one area and the gas discharge can take place in a favorable direction, namely downwards. The implementation is also concept-neutral. As with a beverage can, in which a drinking opening is made solely by the material properties of the aluminum and is provided by a targeted pre-notch, the contents can be stored in a defined manner, but can also be broken open in a defined manner. In the present example as well, such a predetermined breaking point can be provided in numerous variations by targeted notching of an active ingredient.

1. A battery arrangement, comprising: a housing base arrangement and at least one battery unit which is arranged on the housing base arrangement and is arranged above the housing base arrangement with respect to a first direction and which comprises at least one battery cell, wherein the at least one battery cell has a first side having a releasable degassing opening which is releasable for discharging a gas from the at least one battery cell, wherein the housing base arrangement has at least one predetermined breaking point, which is designed, in dependence on a gas escape of a gas from the degassing opening of the at least one battery cell, to release an opening penetrating the housing base arrangement with respect to the first direction, in order to discharge the gas escaping from the degassing opening of the at least one battery cell through the released opening.

2. The battery arrangement of claim 1, wherein the battery unit is arranged on the housing base arrangement in such a way that the first side of the at least one battery cell faces toward the housing base arrangement.

3. The battery arrangement of claim 1, wherein the housing base arrangement comprises a housing base which is designed as a cooling base through which a coolant can flow.

4. The battery arrangement of claim 1, wherein the housing base arrangement has a housing base and an electrically insulating layer, in particular a plastic film, which is arranged between the battery unit and the housing base, and/or a thermal interface layer, which is arranged between the battery unit and the housing base, for thermally coupling the housing base and the battery unit.

5. The battery arrangement of claim 1, wherein the predetermined breaking point is formed as a local weakening of the housing base, in particular wherein the local weakening is provided by:
a material weakening; and/or
a connecting point, in particular a weakened connecting point, at which a first part of the housing base is connected to a second part of the housing base.

6. The battery arrangement of claim 1, wherein the predetermined breaking point is formed as a local weakening of an element of the housing base arrangement which is different from the housing base, in particular as a material weakening of the element which is different from the housing base.

7. The battery arrangement of claim 6, the material weakening is provided by:
at least one perforation line, which extends in a straight or curved manner, in particular as an open or as a closed line; and/or
a material taper along at least one line which extends straight or curved, in particular open or as a closed line; and/or
a hole, corresponding to the size of the opening to be released, in an element of the housing base arrangement, which hole is covered by a further element of the housing base arrangement, when no gas escapes from the at least one battery cell; and/or
at least one blind hole, which corresponds to the size of the opening to be released, and/or multiple blind holes extending along at least one line.

8. The battery arrangement of claim 1, wherein the releasable degassing opening of the at least one battery cell adjoins a cavity which provides a gas discharge channel and which is delimited with respect to the first direction by at least one part of the housing base arrangement, in particular at least the housing base and the electrically insulating layer located on the housing base.

9. The battery arrangement of claim 1, wherein the releasable degassing opening of the at least one battery cell is directly adjoining the housing base arrangement, wherein the predetermined breaking point is unambiguously associated with the degassing opening in that the predetermined breaking point is arranged directly below the degassing opening with respect to the first direction.

10. A method for discharging a gas from a battery arrangement having a housing base arrangement and at least one battery unit which is arranged on the housing base arrangement and is arranged above the housing base arrangement with respect to a first direction and which comprises at least one battery cell, wherein the at least one battery cell has a first side having a releasable degassing opening which is released for discharging a gas from the at least one battery cell, wherein the housing base arrangement has at least one predetermined breaking point, which releases, in dependence on a gas escape of a gas from the degassing opening of the at least one battery cell, an opening penetrating the housing base arrangement with respect to the first direction, in order to discharge the gas escaping from the degassing opening of the at least one battery cell through the released opening.

11. The battery arrangement of claim 2, wherein the housing base arrangement comprises a housing base which is designed as a cooling base through which a coolant can flow.

12. The battery arrangement of claim 3, wherein the housing base arrangement has a housing base and an electrically insulating layer, in particular a plastic film, which is arranged between the battery unit and the housing base, and/or a thermal interface layer, which is arranged between the battery unit and the housing base, for thermally coupling the housing base and the battery unit.

13. The battery arrangement of claim 2, wherein the predetermined breaking point is formed as a local weakening of the housing base, in particular wherein the local weakening is provided by:
a material weakening; and/or
a connecting point, in particular a weakened connecting point, at which a first part of the housing base is connected to a second part of the housing base.

14. The battery arrangement of claim 3, wherein the predetermined breaking point is formed as a local weakening of the housing base, in particular wherein the local weakening is provided by:
a material weakening; and/or
a connecting point, in particular a weakened connecting point, at which a first part of the housing base is connected to a second part of the housing base.

15. The battery arrangement of claim 4, wherein the predetermined breaking point is formed as a local weakening of the housing base, in particular wherein the local weakening is provided by:
a material weakening; and/or
a connecting point, in particular a weakened connecting point, at which a first part of the housing base is connected to a second part of the housing base.

16. The battery arrangement of claim 2, wherein the predetermined breaking point is formed as a local weakening of an element of the housing base arrangement which is different from the housing base, in particular as a material weakening of the element which is different from the housing base.

17. The battery arrangement of claim 3, wherein the predetermined breaking point is formed as a local weakening of an element of the housing base arrangement which is different from the housing base, in particular as a material weakening of the element which is different from the housing base.

18. The battery arrangement of claim 4, wherein the predetermined breaking point is formed as a local weakening of an element of the housing base arrangement which is different from the housing base, in particular as a material weakening of the element which is different from the housing base.

19. The battery arrangement of claim 2, wherein the releasable degassing opening of the at least one battery cell is directly adjoining the housing base arrangement, wherein the predetermined breaking point is unambiguously associated with the degassing opening in that the predetermined breaking point is arranged directly below the degassing opening with respect to the first direction.

20. The battery arrangement of claim 3, wherein the releasable degassing opening of the at least one battery cell is directly adjoining the housing base arrangement, wherein the predetermined breaking point is unambiguously associated with the degassing opening in that the predetermined breaking point is arranged directly below the degassing opening with respect to the first direction.
